(19) United States
(12) Patent Application Publication
(10) Pub. No.: US 2026/0051663 A1
(43) Pub. Date: Feb. 19, 2026

(54) COMMUNICATION SYSTEM AND COMMUNICATION METHOD

(71) Applicant: KYOCERA Corporation, Kyoto-shi, Kyoto (JP)

(72) Inventors: Nobuki HIRAMATSU, Yokohama-shi, Kanagawa (JP); Masamichi YONEHARA, Yokohama-shi, Kanagawa (JP); Takafumi UEHAMA, Fujisawa-shi, Kanagawa (JP)

(21) Appl. No.: 19/104,070

(22) PCT Filed: Aug. 9, 2023
(86) PCT No.: PCT/JP2023/029153

§ 371 Date: Feb. 14, 2025

(30) Foreign Application Priority Data
Aug. 25, 2022 (JP) 2022-134372

(51) Int. Cl. H01Q 15/02; H01Q 1/24

(52) U.S. Cl. CPC H01Q 15/02; H01Q 1/246

(57) ABSTRACT

A communication system includes a base station configured to transmit and receive a radio wave and installed in an exterior, a radio wave focusing plate configured to receive the radio wave transmitted from the base station and emit the radio wave with a boundary between exterior and an interior as a focal point, and a terminal apparatus configured to receive the radio wave emitted from the radio wave focusing plate and communicate with the base station.

### TECHNICAL FIELD

The present disclosure relates to a communication system and a communication method.

### BACKGROUND OF INVENTION

When high-speed communication is performed in a collective housing such as an apartment building, a wired connection using an optical line or the like, or a fixed wireless access (FWA) utilizing public LTE is utilized (e.g., Patent Document 1).

### CITATION LIST

### Patent Literature

Patent Document 1: JP 2017-17643 A

### SUMMARY

A communication system of the present disclosure includes a base station configured to transmit and receive a radio wave and installed in an exterior, a radio wave focusing plate configured to receive the radio wave transmitted from the base station and emit the radio wave with a boundary between the exterior and an interior as a focal point, and a terminal apparatus configured to receive the radio wave emitted from the radio wave focusing plate and communicate with the base station.

A communication method of the present disclosure includes transmitting and receiving a radio wave, receiving, at a radio wave focusing plate, the radio wave transmitted and emitting the radio wave with a boundary between an exterior and an interior as a focal point, and receiving the radio wave emitted from the radio wave focusing plate and communicating with a base station.

### BRIEF DESCRIPTION OF THE DRAWINGS

FIG. 1 is a diagram illustrating a configuration example of a communication system according to a first embodiment.

FIG. 2 is a diagram illustrating a configuration example of a radio wave focusing plate according to the first embodiment.

FIG. 3 is a diagram for illustrating a focal position of a radio wave focusing plate according to a second embodiment.

FIG. 4 is a diagram for illustrating an installation position of a terminal apparatus according to a third embodiment.

FIG. 5 is a diagram for illustrating a method of installing a radio wave focusing plate according to a fourth embodiment.

FIG. 6 is a diagram for illustrating an installation angle of a radio wave focusing plate according to a fifth embodiment.

FIG. 7 is a diagram for illustrating a method of installing a plurality of radio wave focusing plates according to a first example of a sixth embodiment.

FIG. 8 is a diagram for illustrating a method of installing a plurality of radio wave focusing plates according to a second example of the sixth embodiment.

### DESCRIPTION OF EMBODIMENTS

In the following, embodiments of the present invention will be described in detail with reference to the accompanying drawings. The present invention is not limited by the embodiments, and in the following embodiments, the same reference signs are assigned to the same portions and redundant descriptions thereof will be omitted.

### First Embodiment

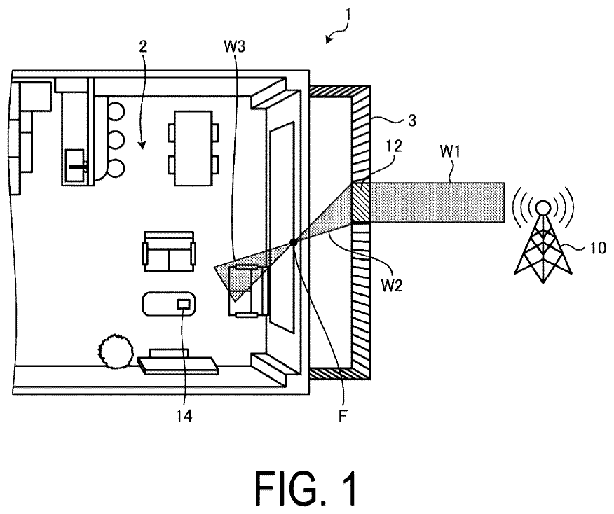

A configuration example of a communication system according to a first embodiment will be described with reference to FIG. 1. FIG. 1 is a diagram illustrating the configuration example of the communication system according to the first embodiment.

As illustrated in FIG. 1, a communication system 1 includes a base station 10, a radio wave focusing plate 12, and a terminal apparatus 14. The communication system 1 may be, for example, a communication system compatible with a millimeter wave communication capable of performing large-capacity data communication in high speed, such as a fifth generation mobile communication system (hereinafter, also referred to as the “5G”) or a sixth generation mobile communication system (hereinafter, also referred to as the “6G”).

The communication system 1 is configured to allow appropriately communication between the base station 10 and the terminal apparatus 14 in each room of a collective housing such as an apartment building. Specifically, the communication system 1 is configured to be able to effectively lead a radio wave from the base station 10 into a room 2 when the window glass of the room 2 of the collective housing is a heat ray reflecting glass or a heat ray absorbing glass or the like through which a radio wave from the base station 10 is hard to transmit.

The base station 10 is installed in an exterior. The base station 10 is configured to perform wireless communication with the terminal apparatus 14. The base station 10 is configured to transmit and receive a radio wave (millimeter wave) compatible with the 5G or the 6G to perform wireless communication with the terminal apparatus 14, for example. In the present embodiment, the base station 10 is configured to perform wireless communication with the terminal apparatus 14 via the radio wave focusing plate 12. In the example illustrated in FIG. 1, the base station 10 is configured to transmit a radio wave W1 toward the radio wave focusing plate 12.

The radio wave focusing plate 12 is installed in the exterior. The radio wave focusing plate 12 is formed in a rectangular shape, for example. The shape of the radio wave focusing plate 12 is not limited to the rectangular shape. The radio wave focusing plate 12 is installed on a handrail 3 or the like provided to a veranda of the room 2, for example. The radio wave focusing plate 12 is configured to receive a radio wave from the base station 10 and emits a radio wave W2. The radio wave focusing plate 12 is configured to focus the radio wave W2 on a predetermined position. In the present embodiment, the radio wave focusing plate 12 is configured to focus the radio wave W2 on a focal point F at a boundary between the exterior and an interior of the room 2. In other words, the radio wave focusing plate 12 is configured to have the focal point F at the boundary between the exterior and the interior of the room 2.

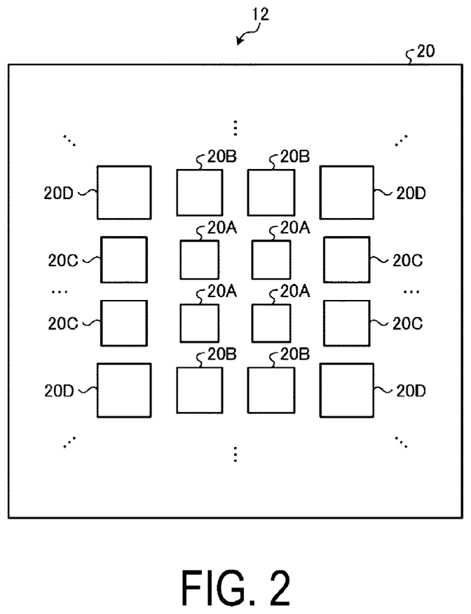

A configuration example of the radio wave focusing plate according to the first embodiment will be described with reference to FIG. 2. FIG. 2 is a diagram illustrating a configuration example of the radio wave focusing plate according to the first embodiment. The radio wave focusing plate 12 is made of a metamaterial changing a phase of an incident wave, for example.

As illustrated in FIG. 2, the radio wave focusing plate 12 may include a substrate 20 and multiple elements 20A, multiple elements 20B, multiple elements 20C, and multiple elements 20D.

The substrate 20 may have a rectangular shape, for example, but is not limited thereto. The elements 20A, 20B, 20C, and 20D may be formed on the substrate 20. The elements 20A, 20B, 20C, and 20D are different in size from one another. For example, the size increases in the order of the elements 20A, 20B, 20C, and 20D. The elements 20A, 20B, 20C, and 20D may be different from each other in the frequency band of the radio wave to be changed and the amount of change in the phase.

The elements 20A, 20B, 20C, and 20D may be arrayed on the substrate 20 in a two-dimensional way. In particular, the element 20A may be disposed at a center portion of the substrate 20. The elements 20B, 20C, and 20D may be disposed around the element 20A. That is, the radio wave focusing plate 12 may be configured by concentrically disposing multiple elements having different sizes. The focal position of the radio wave focusing plate 12 can be adjusted by changing the design of the multiple elements of the radio wave focusing plate.

In the present embodiment, the radio wave focusing plate 12 is not limited to being made of a metamaterial. The radio wave focusing plate 12 may be a dielectric lens or a Fresnel zone plate, for example.

The terminal apparatus 14 is installed in the interior. The terminal apparatus 14 is a communication apparatus such as a smartphone capable of communicating with the base station 10, for example. The terminal apparatus 14 may be a relay apparatus that relays the base station 10 and a communication apparatus such as a smartphone. The terminal apparatus 14 communicates with the base station 10 by receiving a radio wave W3 which is led into the room 2 from the focal point F. Since the radio wave W3 spreads in the room 2, the terminal apparatus 14 can communicate with the base station 10 in a wide region of the room 2.

As described above, in the first embodiment, the radio wave W1 from the base station 10 is focused on the boundary between the exterior and the interior as the radio wave W2 to lead the radio wave W3 into the room. Thus, the first embodiment allows the base station 10 and the terminal apparatus 14 to appropriately perform communication.

### Second Embodiment

A second embodiment will be described. In the present disclosure, the communication system 1 leads a radio wave into the room 2 by focusing the radio wave on the boundary between the exterior and the interior. In this case, the position on which the radio wave is focused is preferably a place where attenuation of the radio wave is relatively small.

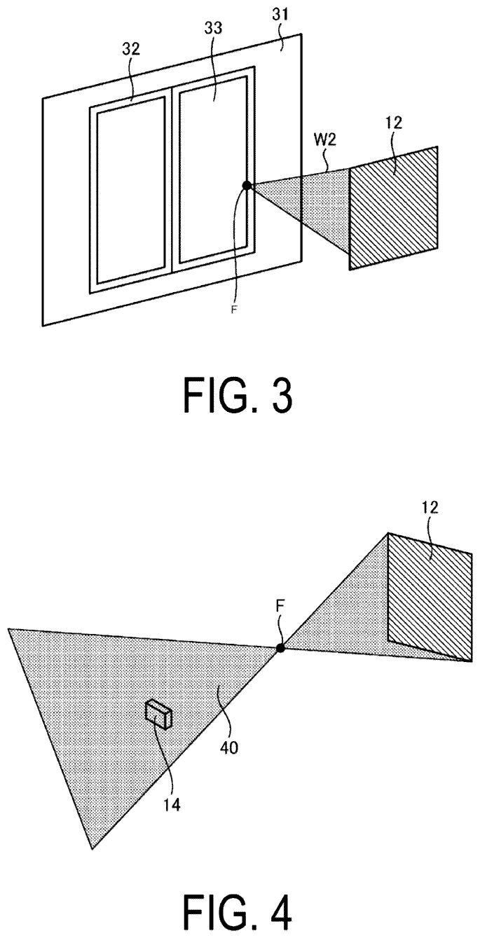

The focal position of the radio wave focusing plate according to the second embodiment will be described with reference to FIG. 3. FIG. 3 is a diagram for illustrating the focal position of the radio wave focusing plate according to the second embodiment.

In FIG. 3, a wall 31, a resin sash 32, and a window glass 33 are illustrated as the boundary between the exterior and the interior of the room 2. The wall 31 is a portion not including a metal member such as a reinforcing bar, for example. The resin sash 32 is a resin sash attached to an outer periphery of the window glass 33. The window glass 33 is an ordinary glass member. That is, the wall 31, the resin sash 32, and the window glass 33 are portions of the boundary between the exterior and the interior of the room 2 at which attenuation of a radio wave is relatively small. In the second embodiment, the focal point F of the radio wave focusing plate 12 is positioned on the wall 31, the resin sash 32, and the window glass 33. This can avoid the attenuation of the radio wave W2 emitted from the radio wave focusing plate 12 at the boundary between the exterior and the interior of the room 2.

As described above, in the second embodiment, the radio wave W1 from the base station 10 is focused as the radio wave W2 on a portion of the boundary between the exterior and the interior, at which attenuation of a radio wave is assumed to be small, to lead the radio wave W3 into the room 2. Thus, the second embodiment can increase electrical power of the radio wave W3 received by the terminal apparatus 14.

### Third Embodiment

A third embodiment will be described. In the present disclosure, the base station 10 and the terminal apparatus 14 communicate with each other by the radio wave W3 led into the room 2. In this case, the terminal apparatus 14 is preferably installed at a position where the radio wave W3 led into the room 2 may easily be received.

An installation position of the terminal apparatus according to the third embodiment will be described with reference to FIG. 4. FIG. 4 is a diagram for illustrating the installation position of the terminal apparatus according to the third embodiment.

As illustrated in FIG. 4, in the third embodiment, the terminal apparatus 14 is preferably disposed in a region 40 formed by straight lines obtained by extending, to the interior, straight lines from points on a peripheral edge of the radio wave focusing plate 12 to the focal point F. In the example illustrated in FIG. 4, for example, multiple points are set along an outer periphery of the radio wave focusing plate 12 at predetermined intervals. The terminal apparatus 14 is disposed in the region 40 formed by multiple straight lines obtained by extending, to the interior, straight lines from respective multiple set points to the focal point F on the peripheral edge. The region 40 is a region where the radio wave W3 spreads. Disposing the terminal apparatus 14 in the region 40 makes it possible for the terminal apparatus 14 to appropriately receive the radio wave W3.

As described above, in the third embodiment, the terminal apparatus 14 is disposed in the region 40 where the radio wave W3 led into the room 2 spreads. Thus, the third embodiment allows the base station 10 and the terminal apparatus 14 to appropriately communicate with each other.

### Fourth Embodiment

A fourth embodiment will be described. In the present disclosure, the radio wave W1 transmitted by the base station 10 is focused on the boundary between the exterior and the interior as the radio wave W2 by the radio wave focusing plate 12 to lead the radio wave W3 into the room 2. In this case, when a size of the radio wave focusing plate 12 is small, sufficient electrical power may not be obtained.

In the fourth embodiment, the radio wave focusing plate 12 is preferably installed in a Fresnel zone that is defined based on a linear distance between the base station 10 and the radio wave focusing plate 12 and a linear distance between the radio wave focusing plate 12 and the focal point F.

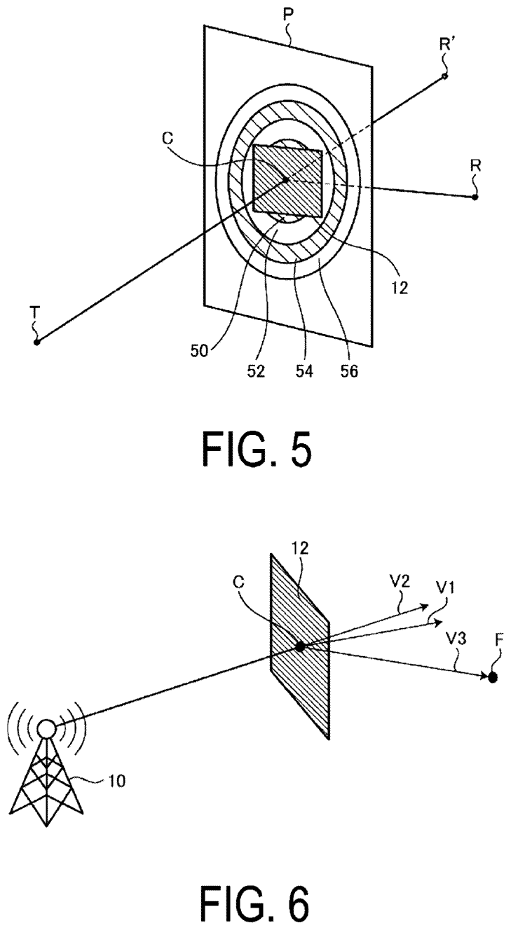

An installation method of the radio wave focusing plate according to the fourth embodiment will be described with reference to FIG. 5. FIG. 5 is a diagram for illustrating the installation method of the radio wave focusing plate according to the fourth embodiment.

In the example illustrated in FIG. 5, a center point C indicates a center point of the radio wave focusing plate 12. A transmission point T indicates a position of a transmission antenna of the base station 10 illustrated in FIG. 1. A reception point R indicates a position of the focal point F illustrated in FIG. 1. A reception point R′ indicates a virtual focal position. That is, in the example illustrated in FIG. 5, a linear distance between the center point C and the reception point R and a linear distance between the center point C and the reception point R′ are the same. Given a path of the radio wave that reaches the reception point R from the transmission point T passing through a point on the radio wave focusing plate 12, the radio wave focusing plate 12 is installed in a region in which radio waves strengthen each other. Thus, the present embodiment can obtain higher received power. In the present embodiment, a region in which radio waves strengthen each other is referred to as an odd-order Fresnel zone, and a region in which radio waves weaken each other is referred to as an even-order Fresnel zone.

As illustrated in FIG. 5, a situation in which a radio wave from the transmission point T passes through the radio wave focusing plate 12 and reaches the reception point R is considered. Let d₁ be a linear distance between the transmission point T and the center point C. Let d2 be a linear distance between the reception point R and the center point C. A flat surface P perpendicular to a straight line, coupling the transmission point T and the reception point R′ passing through the center point C, is considered. Here, a circle on the flat surface P, of which center is the center point C, having a radius defined by the following Equation (1) is considered.

$$\begin{matrix}[ Math 1 ] & \\ {R}_{n} = \sqrt{\frac{n λ {d}_{1} {d}_{2}}{{d}_{1} + {d}_{2}}} & ( 1 )\end{matrix}$$

In Equation (1), n is a natural number, and λ is a wavelength of the radio wave.

In the present embodiment, in Equation (1), an annular portion in a range from a radius Rn-1 to a radius Rn is defined as an n-th Fresnel zone. In the example illustrated in FIG. 5, a first Fresnel zone 50, a second Fresnel zone 52, a third Fresnel zone 54, and a fourth Fresnel zone 56 are illustrated. For example, a range of a circle having a radius R1 is the first Fresnel zone 50. For example, a range of an annular portion from a circle having a radius R1 to a circle having a radius R2 is the second Fresnel zone 52.

A length of one side of the radio wave focusing plate 12 is preferably equal to or

greater than a radius of the first Fresnel zone 50. Specifically, the length of one side of the radio wave focusing plate 12 is preferably twice or more the radius of the first Fresnel zone 50, for example. The radius of the n-th Fresnel zone is also referred to as an n-th Fresnel radius. For example, setting the size of the radio wave focusing plate 12 to be twice or more the first Fresnel radius makes it possible for the base station 10 and the terminal apparatus 14 to appropriately communicate with each other.

As described above, in the fourth embodiment, an area of the radio wave focusing plate 12 is larger than that of the first Fresnel zone. Thus, the fourth embodiment can increase electrical power of the radio wave led into the room.

### Fifth Embodiment

A fifth embodiment will be described. In the present disclosure, the radio wave W1 transmitted by the base station 10 is led into the room 2 by the radio wave focusing plate 12. In this case, depending on an installation angle of the radio wave focusing plate 12, the radio wave W1 transmitted by the base station 10 may not appropriately be focused on the focal point F at the boundary between the exterior and the interior, and sufficient electrical power may not be obtained.

The installation angle of the radio wave focusing plate according to the fifth embodiment will be described with reference to FIG. 6. FIG. 6 is a diagram for illustrating the installation angle of the radio wave focusing plate according to the fifth embodiment.

In FIG. 6, an arrow V1 indicates a direction of a perpendicular line of the radio wave focusing plate 12, an arrow V2 indicates an incident direction of the radio wave W1 from the base station 10 toward the radio wave focusing plate 12, and an arrow V3 indicates a direction from the center point C of the radio wave focusing plate 12 toward the focal point F. In the present embodiment, the radio wave focusing plate 12 is installed such that

when the arrow V1 is projected onto a flat surface formed by the arrow V2 and the arrow V3, the arrow V1 is positioned between the arrow V2 and the arrow V3. This allows the radio wave focusing plate 12 to appropriately focus the radio wave W1 transmitted by the base station 10 on the focal point F.

As described above, in the fifth embodiment, the radio wave focusing plate 12 is installed such that the direction of the perpendicular line of the radio wave focusing plate 12 is positioned between the incident direction of the radio wave W1 from the base station 10 toward the radio wave focusing plate 12 and the direction from the center point C of the radio wave focusing plate 12 toward the focal point F. Thus, the fifth embodiment can appropriately focus the radio wave W1 from the base station 10 on the focal point F, increasing electrical power of a radio wave led into the interior.

### Sixth Embodiment

A sixth embodiment is described. In the present disclosure, the radio wave W1 transmitted by the base station 10 is led into the room 2 by the radio wave focusing plate 12. In this case, since a range is limited where the radio wave W3 led into the room 2 from the radio wave focusing plate 12 reaches, appropriate communication may not be possible if the position of the terminal apparatus 14 is changed. In the sixth embodiment, a plurality of the radio wave focusing plates 12 are installed to lead the radio wave W1 into the room 2.

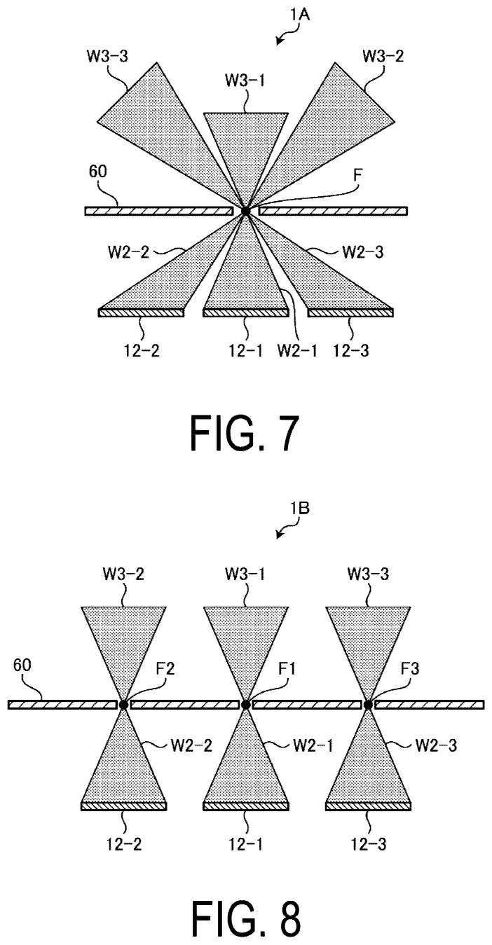

A method of installing a plurality of radio wave focusing plates according to a first example of the sixth embodiment will be described with reference to FIG. 7. FIG. 7 is a diagram for illustrating a method of installing the plurality of radio wave focusing plates according to the first example of the sixth embodiment.

As illustrated in FIG. 7, a communication system 1A includes radio wave focusing plates 12-1, 12-2, and 12-3 as the radio wave focusing plate 12. The number of radio wave focusing plates 12 included in the communication system 1A is not limited.

The radio wave focusing plates 12-1, 12-2, and 12-3 may be arranged side by side. The radio wave focusing plate 12-1 is configured to focus the radio wave W1 received from the base station 10 as a radio wave W2-1 on a focal point F, which is set at a structure 60 provided between the exterior and the interior. The radio wave focusing plate 12-2 is configured to focus the radio wave W1 received from the base station 10 on the focal point F as a radio wave W2-2. The radio wave focusing plate 12-3 is configured to focus the radio wave W1 received from the base station 10 on the focal point F as a radio wave W2-3. In other words, the radio wave focusing plates 12-1, 12-2, and 12-3 each focus a radio wave on the same focal point.

The radio wave W2-1 reaches the interior from the focal point F as a radio wave W3-1. The radio wave W2-2 reaches the interior from the focal point F as a radio wave W3-2. The radio wave W2-3 reaches the interior from the focal point F as a radio wave W3-3. This allows the communication system 1A to lead the radio wave W1 transmitted by the base station 10 over a wide range.

A method of installing the plurality of radio wave focusing plates according to a second example of the sixth embodiment will be described with reference to FIG. 8. FIG. 8 is a diagram for illustrating a method of installing the plurality of radio wave focusing plates according to the second example of the sixth embodiment.

As illustrated in FIG. 8, a communication system 1B includes the radio wave focusing plates 12-1, 12-2, and 12-3 as the radio wave focusing plate 12. The communication system 1B is different from the communication system 1A illustrated in FIG. 7 in that the radio wave focusing plates 12-1, 12-2, and 12-3 focus a radio wave on respective different focal points.

The radio wave focusing plate 12-1 is configured to focus the radio wave W1 received from the base station 10 on the focal point F1 set at the structure 60 as the radio wave W2-1. The radio wave focusing plate 12-2 is configured to focus the radio wave W1 received from the base station 10 on the focal point F2 set at the structure 60 as the radio wave W2-2. The radio wave focusing plate 12-3 is configured to focus the radio wave W1 received from the base station 10 on the focal point F3 set at the structure 60 as the radio wave W2-3.

The radio wave W2-1 reaches the interior from the focal point F1 as the radio wave W3-1. The radio wave W2-2 reaches the interior from the focal point F2 as the radio wave W3-2. The radio wave W2-3 reaches the interior from the focal point F3 as the radio wave W3-3. This allows the communication system 1B to lead the radio wave W1 transmitted by the base station 10 into the interior over a wide range.

As described above, in the sixth embodiment, the radio wave W1 from the base station 10 is led into the interior over a wide range by using the plurality of radio wave focusing plates 12. Thus, the sixth embodiment allows, even when the position of the terminal apparatus 14 changes, the terminal apparatus 14 to appropriately communicate with the base station 10.

Embodiments of the present disclosure have been described above, but the present disclosure is not limited by the contents of the embodiments. Constituent elements described above include those that can be easily assumed by a person skilled in the art, those that are substantially identical to the constituent elements, and those within a so-called range of equivalency. The constituent elements described above can be combined as appropriate. Various omissions, substitutions, or modifications of the constituent elements can be made without departing from the spirit of the above-described embodiments.

### REFERENCE SIGNS

1, 1A, 1B Communication system
10 Base station
12, 12-1, 12-2, 12-3 Radio wave focusing plate
14 Terminal apparatus
20 Substrate
20A, 20B, 20C, 20D Element
31 Wall
32 Resin sash
33 Window glass
50 First Fresnel zone
52 Second Fresnel zone
54 Third Fresnel zone
56 Fourth Fresnel zone
60 Structure

1. A communication system, comprising:
a base station configured to transmit and receive a radio wave and installed in an exterior;
a radio wave focusing plate configured to receive the radio wave transmitted from the base station and emit the radio wave with a boundary between the exterior and an interior as a focal point; and
a terminal apparatus configured to receive the radio wave emitted from the radio wave focusing plate and communicate with the base station.

2. The communication system according to claim 1,
wherein the radio wave focusing plate is configured to focus the radio wave at a position of the boundary between the exterior and the interior where attenuation of the radio wave is relatively small.

3. The communication system according to claim 2
wherein the radio wave focusing plate is configured to focus the radio wave on any one of a window glass, a resin sash attached to an outer periphery of the window glass, and a wall portion not comprising a metal member, which are provided at the boundary between the exterior and the interior.

4. The communication system according to claim 1,
wherein in the interior, the terminal apparatus is installed in a region formed by straight lines obtained by extending straight lines from points on a peripheral edge of the radio wave focusing plate to the focal point.

5. The communication system according to claim 1,
wherein a length of one side of the radio wave focusing plate is equal to or greater than a radius of a first Fresnel zone defined from a positional relationship among the base station, the radio wave focusing plate, and the terminal apparatus.

6. The communication system according to claim 1,
wherein the radio wave focusing plate is installed with a direction of a perpendicular line of the radio wave focusing plate being between an incident direction of the radio wave toward the radio wave focusing plate and a direction from a center of the radio wave focusing plate toward the focal point.

7. The communication system according to claim 1, comprising one or more radio wave focusing plates.

8. The communication system according to claim 7,
wherein the one or more radio wave focusing plates are configured to have the same focal position.

9. The communication system according to claim 7,
wherein the one or more radio wave focusing plates are configured to have different focal positions.

10. A communication method, comprising:
transmitting and receiving a radio wave;
receiving, at a radio wave focusing plate, the radio wave transmitted and emitting the radio wave with a boundary between an exterior and an interior as a focal point; and
receiving the radio wave emitted from the radio wave focusing plate and communicating with a base station.
